(19) United States
(12) Patent Application Publication
(10) Pub. No.: US 2002/0118264 A1
(43) Pub. Date: Aug. 29, 2002

(54) Ink reservoir for writing refill

(76) Inventor: Makoto Fukushima, Kawagoe-shi (JP)

Correspondence Address: McGinn & Gibb, PLLC, Suite 200, 8321 Old Courthouse Road, Vienna, VA, 22182-3817, US

(21) Appl. No.: 10/080,584

(22) Filed: Feb. 25, 2002

(30) Foreign Application Priority Data
Feb. 26, 2001 (JP) 2001-103901

(51) Int. Cl. B41J 2/175

(52) U.S. Cl. 347/86; 347/87

(57) ABSTRACT

An ink reservoir for an ink refill has a stalk-like front portion, a tubular body portion, and a transitional portion between the stalk-like front portion and the tubular body portion. The transitional portion has a tapered inner surface tapered gently from a boundary between the tubular body portion and the transitional portion toward the stalk-like front portion.

### BACKGROUND OF THE INVENTION

The present invention relates to an ink reservoir for a writing refill and, more particularly, to improvements in an ink reservoir for containing a gel ink or an oil-base ink.

Generally, an ink reservoir for a writing refill for a ballpoint pen or the like has a tubular body portion having a large inside diameter, and a stalk-like front portion having a small inside diameter smaller than that of the tubular body portion and extending from the front end of the tubular body portion. A writing tip is fitted in a front end part of the stalk-like front portion by a press fit.

In the prior art ink reservoir 1 configured as shown in FIG. 1, a tapered round step 4 sharply tapered toward the stalk-like front portion 3 is formed on the inner surface of the joint of the tubular body portion 2 and the stalk-like front portion 3. More concretely, an angle corresponding to the taper of the tapered round step 4, i.e., the angle between diametrically opposite generatrices of the tapered round step 4, is in the range of 60° to 90°.

Generally, when filling the ink reservoir 1 with an ink, the ink is not injected through the back end of the tubular body portion 2 having the large inside diameter into the ink reservoir 1, and is injected through the front end of the stalk-like front portion 3 having the small inside diameter into the ink reservoir 1 to restrict the inclusion of air in the ink to the least possible extent.

Any problem does not arise when, for example, an oil-base ink having a high viscosity on the order of 10,000 cps is filled in the conventional ink reservoir 1. However, since the tapered round step sharply tapered toward the stalk-like front portion 3 is formed on the inner surface of the joint of the tubular body portion 1 and the stalk-like front portion 3, when an ink having a low viscosity below 5,000 cps is injected through the stalk-like front portion 3 into the tubular body portion 2, air mingles with the ink in the vicinity of the tapered round step 4 and forms an air-filled space around the tapered round step 4. More specifically, whereas an ink having a high viscosity flows slowly and hence is not apt to cause air to mingle with the ink, an ink having a low viscosity flows rapidly and hence air is apt to mingle with the ink in the vicinity of the tapered round step 4 when the ink flows into the tubular body portion 2.

A writing refill completed by filling the ink reservoir 1 with ink is subjected to deaeration on a centrifuge. However, the centrifuge cannot remove the air in the air-filled space formed around the tapered round step 4. The air remaining in the ink reservoir 1 forms air bubbles in the ink indefinitely changing the volume of the ink filled in the ink reservoir 1. If the ink contained in the ink reservoir 1 of the writing refill includes air bubbles, the pen provided with the writing refill becomes scratchy or the ink leaks from the writing refill when the ambient climate changes.

### SUMMARY OF THE INVENTION

The present invention has been made in view of the foregoing in the conventional ink reservoir for a writing refill and it is therefore an object of the present invention to provide an ink reservoir for a writing refill, capable of preventing inclusion of air in an ink when the ink is filled therein.

According to one aspect of the present invention, an ink reservoir has a stalk-like front portion, a tubular body portion, and a transitional portion between the stalk-like front portion and the tubular body portion, wherein the transitional portion has a tapered inner surface tapered gently from the boundary between the tubular body portion and the transitional portion toward the stalk-like front portion.

The inventors of the present invention found through studies that inclusion of air in an ink contained in the ink reservoir can be prevented by gradually tapering the inner surface of the transitional portion toward the stalk-like front portion without forming any steps in the boundaries between the portions. An ink injected into this ink reservoir through the stalk-like front portion flows through the transitional portion having the tapered inner surface gradually expanding toward the tubular body portion into the tubular body portion and hence the ink does not include air.

Preferably, an angle corresponding to the taper of the tapered inner surface of the transitional portion is in the range of 4° to 40°. It was found through studies that even an ink having a low viscosity and capable of flowing rapidly into the tubular body portion can be filled satisfactorily in the tubular body portion without including air when the angle corresponding to the taper of the tapered inner surface of the transitional portion is in the range of 4° to 40°.

### BRIEF DESCRIPTION OF THE DRAWINGS

The above and other objects, features and advantages of the present invention will become more apparent from the following description taken in connection with the accompanying drawings, in which:

FIG. 1 is a longitudinal sectional view of a conventional ink reservoir for a writing refill;

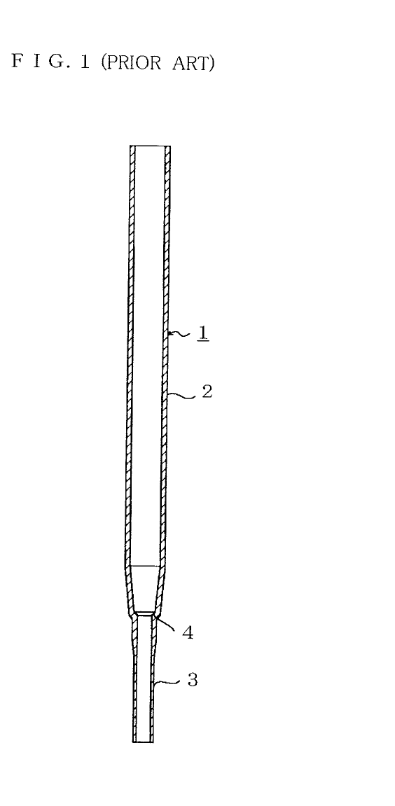

FIG. 2 is an exploded, longitudinal sectional view of a refill for a ballpoint pen employing a ink reservoir in a preferred embodiment according to the present invention; and

FIG. 3 is a front elevation of the refill shown in FIG. 2.

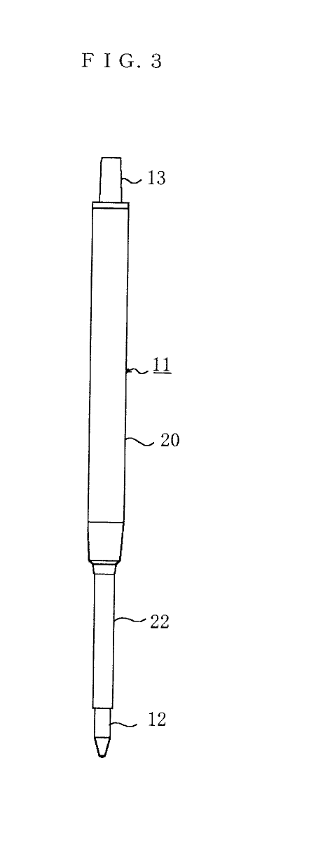

### DESCRIPTION OF THE PREFERRED EMBODIMENTS

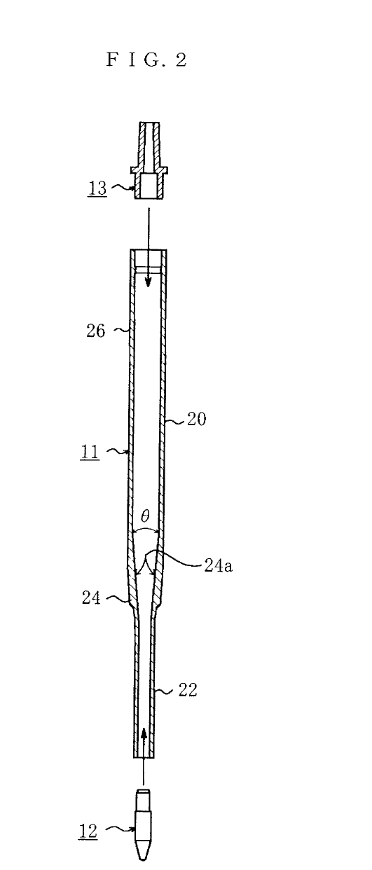

An ink reservoir 11 in an embodiment according to the present invention shown in FIG. 2 is used for forming a refill for a ballpoint pen. Referring to FIG. 2, the ink reservoir 11 has a tubular body portion 20 having a large inside diameter, a stalk-like front portion 22 having a small inside diameter smaller than that of the tubular body portion 20, and a transitional portion 24 between the tubular body portion 20 and the stalk-like front portion 22. A known writing tip 12 is press-fitted in the front end part of the stalk-like front portion 22. The transitional portion 24 has a tapered inner surface 24a gently tapered from the boundary between the tubular body portion 20 and the transitional portion 24 toward the stalk-like front portion 22, i.e., expanding toward the tubular body portion 20.

The inventors of the present invention found through studies that inclusion of air in an ink contained in the ink reservoir can be prevented by gradually tapering the inner surface of the transitional portion 24 toward the stalk-like front portion 22. It was found through studies that when the angle corresponding to the taper of the tapered inner surface of the transitional portion is in the range of 4° to 40°. An angle θ corresponding to the taper of the tapered inner surface 24a of the transitional portion 24, i.e., the angle between diametrically opposite generatrices of the tapered inner surface 24a, is 10° in this embodiment.

When filling the ink reservoir 11 with an ink, the ink is not injected through the back end 26 of the tubular body portion 20 having the large inside diameter and is injected through the stalk-like front portion 22 having the small inside diameter into the ink reservoir 11 to restrict the inclusion of air in the ink to the least possible extent. Since the ink flows along the tapered inner surface 24a gradually expanding toward the tubular body portion 20 and fills up the tubular body portion 20, the ink does not include air.

After the ink reservoir 11 has been thus filled up with the ink, the writing tip 12 is press-fitted in the front end part of the stalk-like front portion 22. Then an ink follower, not shown, such as grease, is injected through the back end 26 of the tubular body portion 20 into the tubular body portion 20 and an end plug 13 is fitted in the back end 26 of the tubular body portion 20 to complete a writing refill for a ballpoint pen. The writing refill is subjected to a deaeration process on a centrifuge.

As apparent from the foregoing description, according to the present invention, the ink reservoir does not permit the ink to include air when the same is poured into the ink reservoir, and contains the ink not including air. Thus the apparent volume of the ink contained in the ink reservoir is equal to the actual volume of the ink, the ballpoint pen provided with the writing refill does not become scratchy or the ink does not leak from the writing refill.

What is claimed is:

1. An ink reservoir for a writing refill, comprising a stalk-like front portion, a tubular body portion, and a transitional portion between the stalk-like front portion and the tubular body portion;
wherein the transitional portion has a tapered inner surface gently tapered from a boundary between the tubular body portion and the transitional portion toward the stalk-like front portion without forming any steps in the boundary therebetween.

2. The ink reservoir for a writing refill according to claim 1, wherein an angle corresponding to a taper of the tapered inner surface of the transitional portion is in the range of 4° to 40°.
